(19) United States
(12) Patent Application Publication
(10) Pub. No.: US 2025/0323750 A1
(43) Pub. Date: Oct. 16, 2025

(54) OPTICAL SWITCHING UNIT WITH FREQUENCY SELECTIVE PROTECTION MECHANISM

(71) Applicant: Cisco Technology, Inc., San Jose, CA (US)

(72) Inventors: Alberto Arnaldo Tanzi, Trezzano sul Naviglio (MI) (IT); Giovanni Osnago, La Valletta Brianza (LC) (IT)

(21) Appl. No.: 18/631,551

(22) Filed: Apr. 10, 2024

(51) Int. Cl. H04J 14/02; H04B 10/032

(52) U.S. Cl. CPC H04J 14/0293; H04B 10/032; H04J 14/0221

(57) ABSTRACT

A method for operating an optical protection switching module to protect wave division multiplexed (WDM) optical signals. The method includes receiving a first WDM optical signal at a first receive port of the optical protection switching module, receiving a second WDM optical signal at a second receive port of the optical protection switching module, tapping off a portion of the first WDM optical signal to obtain a tapped portion of the first WDM optical signal, optically filtering the tapped portion of the first WDM optical signal to obtain a predetermined channel of the tapped portion of the first WDM optical signal, detecting a power level of the predetermined channel, and in response to the power level being below a predetermined threshold, causing a switch to enable the second WDM optical signal to pass through the optical protection switching module.

### TECHNICAL FIELD

The present disclosure relates to optical networks and, more particularly, to protection and network management measures and procedures in such networks.

### BACKGROUND

When a fault occurs in the transmission of signals from one network component to another network component, as a result, of, e.g., a break in an optical fiber, protection measures of the optical network may cause the rerouting of the signals around the fault to ensure the delivery of optical signals to their destination. There are different ways to protect optical networks against faults. One protection mechanism used in point-to-point links is the 1+1 mechanism in which a source network component sends duplicate signals on two separate fibers to a destination network component. The destination network component which had been accepting the optical signals over one fiber, called the working fiber, switches to the other fiber, called the protection fiber, in case a fault occurs with the working fiber, to continue receiving the signals. Another protection mechanism is the 1:1 mechanism (a special case of 1:N protection) in which the source network component sends optical signals over the working fiber to the destination network component. In case of a fault in the transmission, the source network component then switches the transmission of optical signals to the protection fiber. In the 1:N mechanism there is one protection fiber for N working fibers.

These protection functions are typically implemented in modules which can be inserted into equipment at different network sites. This form of protection switching is currently performed by sensing the signal optical power on the working and protection lines. This method works well in a case where the optical signal is a single channel optical signal. However, modern optical infrastructure now relies on WDM (Wavelength Division Multiplexing) wherein specific wavelength bands are defined as communication channels on a single fiber. In this disclosure, WDM may be implemented as CWDM (Coarse WDM) or DWDM (Dense WDM), with the latter having, e.g., up to 96 separate channels. In the case of WDM, sensing the total optical power of a given optical fiber with a photodiode does not provide a reliable switching mechanism since the absence of one single channel out of N channels does not relevantly affect the total optical power on that optical fiber.

The capability to protect one specific channel within a WDM comb becomes more important with the introduction of coherent interfaces and with their capability to select a given channel within the WDM comb without the need of any optical filter.

### BRIEF DESCRIPTION OF THE DRAWINGS

FIG. 1 shows an optical network including optical protection switching modules, according to an example embodiment.

FIG. 2 shows details of an optical protection switching module, according to an example embodiment.

FIG. 3 shows a receive section of an optical protection switching module when a given channel n is detected on both a working receiving fiber and a protection receiving fiber, according to an example embodiment.

FIG. 4 shows the receive section of the optical protection switching module when the given channel n is detected as failed on the working receiving fiber and detected on a protection receiving fiber, according to an example embodiment.

FIG. 5 shows the receive section of the optical protection switching module when another channel n+1 is detected as failed on the working receiving fiber, but does not cause switching to the protection receiving fiber, according to an example embodiment.

FIG. 6 is a flowchart showing a series of operations that may be performed by the optical protection switching module, according to an example embodiment.

FIG. 7 is a block diagram of a computing device that may be configured to host control logic of the optical protection switching module and/or to host the optical protection switching module itself, and perform techniques described herein, according to an example embodiment.

### DETAILED DESCRIPTION

### Overview

A method for operating an optical protection switching module to protect wave division multiplexed (WDM) optical signals. The method includes receiving a first WDM optical signal at a first receive port of the optical protection switching module, receiving a second WDM optical signal at a second receive port of the optical protection switching module, tapping off a portion of the first WDM optical signal to obtain a tapped portion of the first WDM optical signal, optically filtering the tapped portion of the first WDM optical signal to obtain a predetermined channel of the tapped portion of the first WDM optical signal, detecting a power level of the predetermined channel, and in response to the power level being below a predetermined threshold, causing a switch to enable the second WDM optical signal to pass through the optical protection switching module.

An optical protection switching module includes a first optical receiving port, a second optical receiving port, an optical switch having respective inputs connected to the first receiving port and the second receiving port, an optical output port connected to an output of the optical switch, switching logic configured to control which of the first optical receiving port and the second optical receiving port is connected to the optical output port, a first optical filter, tuned to a predetermined channel, in communication with the first optical receiving port, and a first photo detector in communication with an output of the first optical filter, wherein the switching logic, in response to an output of the first photo detector, is configured to cause the optical switch to enable one of the first optical receiving port and the second optical receiving port to be optically connected to the output of the optical switch.

A system may also include a working optical path, a protection optical path, and an optical protection switching module configured to enable communication via one of the working optical path and the protection optical path, the optical protection switching module including a first optical receiving port, a second optical receiving port, an optical switch having respective inputs connected to the first optical receiving port and the second optical receiving port, an optical output port connected to an output of the optical switch, switching logic configured to control which of the first optical receiving port and the second optical receiving port is connected to the optical output port, a first optical filter, tuned to a predetermined channel of a wave division multiplexed (WDM) optical signal, in communication with the first optical receiving port; and a first photo detector in communication with an output of the first optical filter.

### Example Embodiments

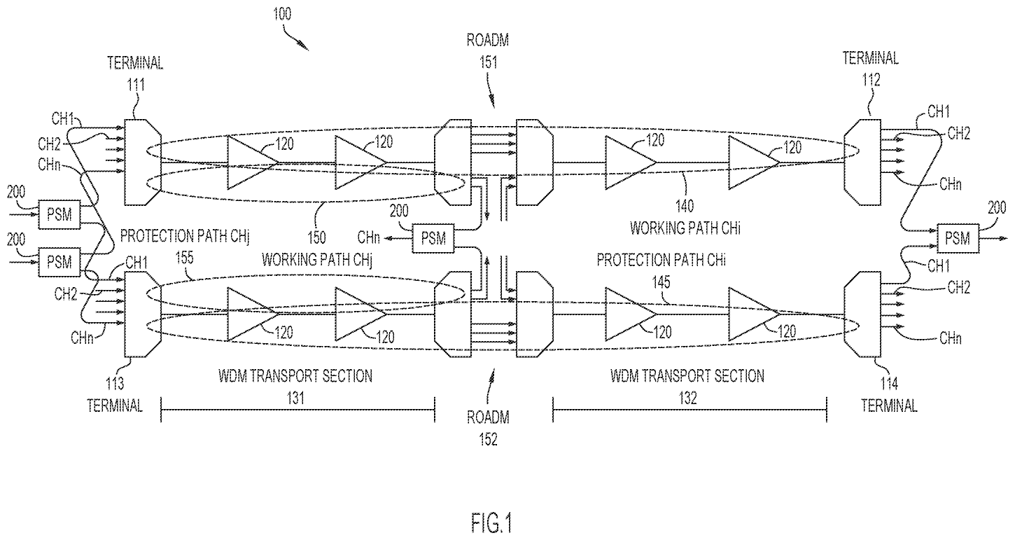

FIG. 1 shows an optical network 100 including optical protection switching modules, or optical PSMs 200, according to an example embodiment. Optical network 100 includes a first terminal 111, one or more optical amplifiers 120, a first reconfigurable optical add-drop multiplexer, or first ROADM 151, a second terminal 112, a third terminal 113, a second ROADM 152, and a fourth terminal 114. In the example network of FIG. 1, a CHᵢ working path 140 includes first terminal 111, first ROADM 151, and second terminal 112. A CHᵢ protection path includes third terminal 113, second ROADM 152, and fourth terminal 114. Similarly, a CHⱼ working path 150 includes first terminal 111 and first ROADM 151, and a CHⱼ protection path 155 includes third terminal 113 and second ROADM 152. The several components mentioned above and depicted in FIG. 1 are connected to one another via optical fibers, as shown.

In operation, and as an example, modulated optical signals for each of the plurality of WDM channels (CH₁, CH₂, . . . . CHₙ) are input to, e.g., first terminal 111 where they are multiplexed so that the signals are combined for transmission as a WDM signal. The one or more optical amplifiers 120 boost the WDM signal for transmission through the fiber link. At the other end of the link or path, in this case, second terminal 112, demultiplexes the WDM signal into respective channels for termination or further processing.

First ROADM 151 may also demultiplex the WDM signal and then add/drop selected channels in accordance with instructions from, e.g., a network operator.

Several optical protection switching modules, or optical PSMs 200, are depicted in FIG. 1. In the example shown, one set of optical PSMs 200 is configured to monitor optical signals associated with CH₁ of the WDM signals being carried by the optical fibers. Other optical PSMs 200 may be configured to monitor any given channel n. Optical PSM 200 associated with first ROADM 151 and second ROADM 152 is depicted as protecting channel n. As will be clear from the following discussion, those skilled in the art will appreciate that optical PSMs 200 may be configured to protect any given channel among WDM channels CH₁, CH₂, . . . . CHₙ.

A first WDM transport section 131 is defined as being between, e.g., first terminal 111 and first ROADM 151, or between third terminal 113 and second ROADM 152. A second WDM transport section 132 is defined as being between, e.g., first ROADM 151 and second terminal 112, or between second ROADM 152 and fourth terminal 114. Thus, CHᵢ working path 140 and CHᵢ protection path 145 are comprised of first WDM transport section 131 and second WDM transport section 132. CHⱼ working path 150 and CHⱼ protection path 155 are comprised of first WDM transport section 131.

As shown, each optical PSM 200 is deployed as an interface between a network component (e.g., second terminal 112) and the optical fiber of the optical network.

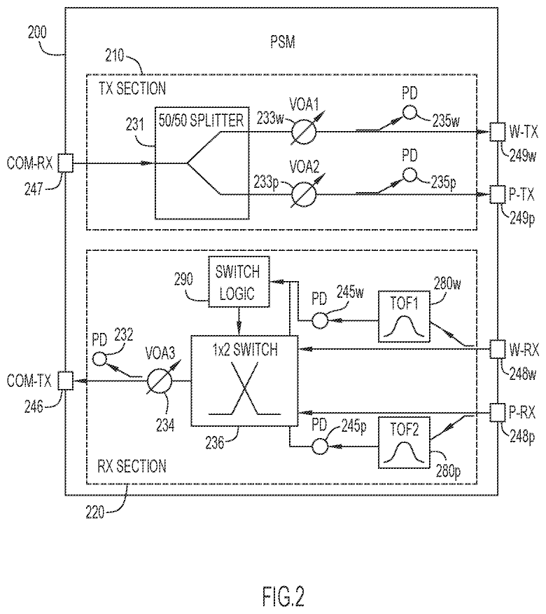

FIG. 2 shows details of optical PSM 200, according to an example embodiment. Optical PSM 200 comprises a transmit (TX) section 210 and a receive (RX) section 220. The TX section 210 includes an input COM-RX port 247 which receives signals to be transmitted from a network component, e.g., first terminal 111 to a corresponding remote network component across an optical fiber. Incoming optical signals are split 50-50 by a splitter 231 for the working transmitting fiber W-TX port 249w and for the protection transmitting fiber P-TX port 249p. Optionally, the power of each set of the split signals is controlled by a Variable Optical Attenuator (VOA1) 233w and VOA2 233p and the effectiveness of each of VOA1 233w and VOA2 233p is monitored by a corresponding PhotoDiode (or photo detector) PD 235w, PD 235p, which receive a small tapped off portion of the signals from the output of VOA1 233w, VOA2 233p, or directly after 50-50 splitter 231 (if VOA1 233w, VOA2 233p are not present).

The RX section 220 includes two input ports, a working receiving W-RX port 248w and a protection receiving P-RX port 248p. The received signals from the W-RX port 248w and P-RX port 248p, received from a corresponding remote network component, are fed into the input terminals of a 1×2 optical switch 236, which selects whether and which of the signals from W-RX port 248w or P-RX port 248p are to be passed to the output COM-TX port 246 and a corresponding optical network component. Optionally, a VOA3 234 controls the power of the signals to the output COM-TX port 246 and the signals are monitored by PD 232, which receives a small tapped off portion of the signals from the output of the VOA3 234, or directly after 1×2 optical switch 236 (if VOA3 234 is not present).

In accordance with an embodiment, RX section 220 also includes, and associated, respectively, with, W-RX port 248w and P-RX port 248p, an optical filter 280w and an optical filter 280p. Optical filter 280w and optical filter 280p may each be tunable optical filters. PD 245w and PD 245p receive a small tapped off portion of the signals from W-RX port 248w and P-RX port 248p, and feed the detected power to switch logic 290, which controls which path is passed through to COM-TX port 246.

Consider, first, the operation of the RX section 220 without optical filter 280w and optical filter 280p in place. In such a configuration, the selection between the two signals from W-RX port 248w and P-RX port 248p after a failure event is performed by the 1×2 optical switch 236 via the switch logic 290 that detects the total optical power on the two lines with the PD 245w and PD 245p. Switch logic 290 has switch criteria based on a threshold crossing of the total optical power level present on the signals received via W-RX port 248w and P-RX port 248p.

As noted in the background section, this basic solution works well in a case in which the signal presence or absence is clearly determined by a certain variation of optical power before/after the failure. In a WDM application, this power variation is clearly detectable in the following cases:
WDM signal with protection mechanism focused on the entire optical spectrum (for, e.g., a Multiplex Section or Line protection); and/or
channel protection in WDM scenario but with an optical filter on the channel termination stage.

The introduction of coherent interfaces in WDM optical transmission provides the ability to select a specific optical channel, among many, without the need of any optical filter. This has greatly simplified the configuration of termination stages in the optical equipment that now can be designed as “colorless” stages, i.e., without any specific assignment port-to-frequency.

Unfortunately, one of the drawbacks of this advancement is that several channels are present on each drop port and, therefore, the presence or absence of one specific channel cannot be identified by clearly detectable optical power variation. On the other hand, including optical filter 280w and optical filter 280p within the RX section 220 of the optical protection switching module 200 as shown, enables channel specific protection even in a WDM context.

More specifically, and still with reference to FIG. 2, two optical filters, namely, optical filter 280w (TOF1) and optical filter 280p (TOF2), are inserted between the W-RX port 248w and P-RX port 248p and the PD 245w and PD 245p on the sensing paths. In operation, both optical filter 280w (TOF1) and optical filter 280p (TOF2) are tuned at the central frequency of the channel in the WDM spectrum that is to be protected. In this way the optical power levels sensed by PD 245w and PD 245p are dominated by the power of the channel that is desired to be protected while all the other WDM channels are filtered out. In this way, the power level variation that is detected in case of a failure of the specific channel is significant, clearly allowing the definition of a failure threshold.

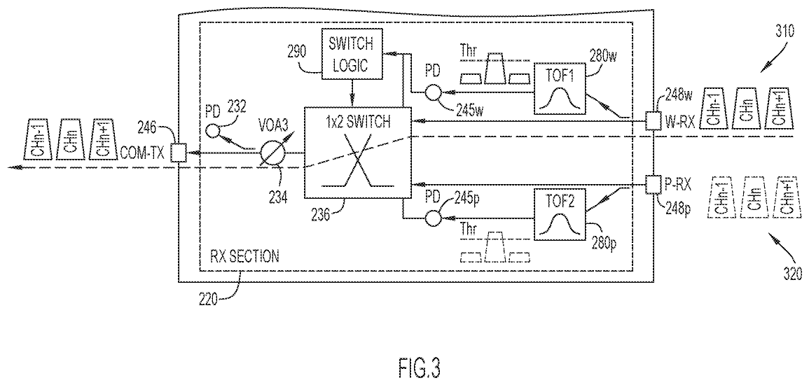

FIG. 3 shows receive section 220 of optical PSM 200 when a given channel n is detected on both a working receiving fiber and a protection receiving fiber, according to an example embodiment. Consider an example of a three channel WDM spectrum including CHn, CHn−1, and CHn+1.

As can be seen in the figure, spectrum 310 and spectrum 320 are similar and are received at W-RX port 248w and P-RX port 248p. In this example, optical filter 280w (TOF1) and optical filter 280p (TOF2) are both tuned at the CHn frequency, which is the channel that is to be given protection. Sensed optical power level at PD 245w and PD 245p are substantially attributable to the CHn signals since the other two channels, CHn−1 and CHn+1, are strongly attenuated by optical filter 280w (TOF1) and optical filter 280p (TOF2). In this way it is possible to define a power level threshold (Thr) above which the channel CHn is considered valid. In the starting condition, the 1×2 optical switch 236 is forwarding the spectrum 310 present on the W-RX port 248w.

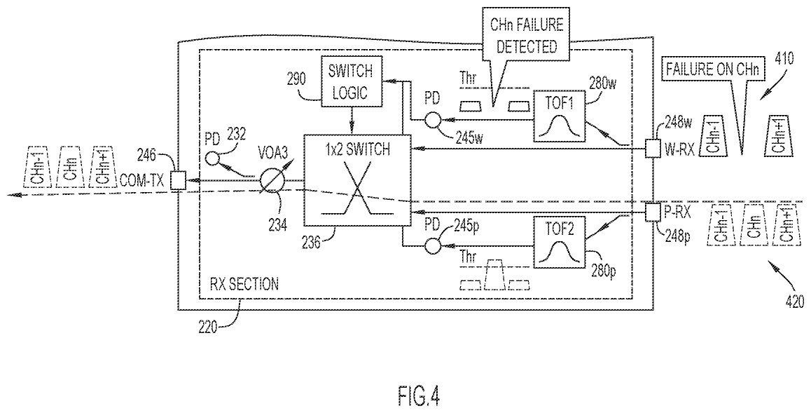

FIG. 4 shows the receive section 220 of the optical PSM 200 when the given channel n is detected as failed on the working receiving fiber and detected on a protection receiving fiber, according to an example embodiment. More specifically, in case of a failure of the channel CHn in spectrum 410 on W-RX port 248w the power level detected by PD 245w drops below the set or predetermined threshold (Thr). If PD 245p is still detecting a power value above the threshold, this means that the spectrum 420 present on P-RX port 248p has a CHn replica still healthy. As a result, switch logic 290 may trigger protection on the 1×2 optical switch 236 to protect the CHn (i.e., forward spectrum 420 received at P-RX port 248p to COM-TX port 246).

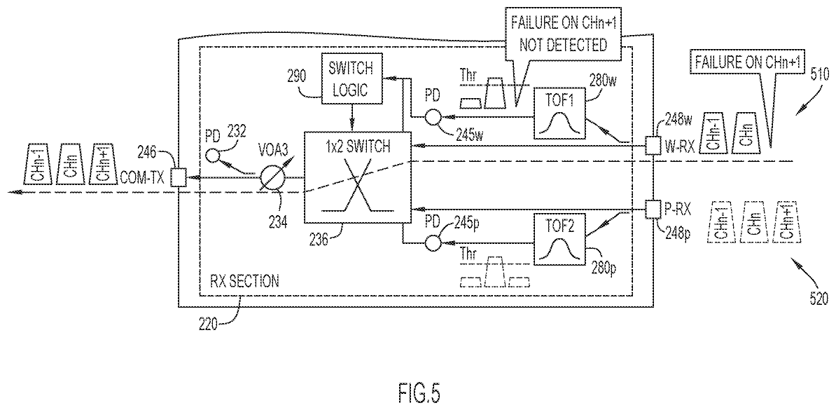

FIG. 5 shows the RX section 220 of optical PSM 200 when another channel n+1 is detected as failed on the working receiving fiber, but does not result in switching to the protection receiving fiber, according to an example embodiment. Assume again, as in FIG. 3, that the 1×2 optical switch 236 is forwarding the spectrum 310 (in this case, spectrum 510, versus spectrum 520) present on the W-RX port 248w. In the case of spectrum 510, and a failure therein of channel CHn+1, the power level detected by PD 245w remains essentially stable and above the threshold (Thr) so protection is not triggered.

Employing optical filter 280w (TOF1) and optical filter 280p (TOF2) in the manner described herein, makes this solution transparent to any type of optical signal bandwidth that is to be protected (i.e., the approach is baud rate transparent). Those skilled in the art will appreciate that to optimize the methodology, the definition or design of the optical filters including their optical bandwidth and shape should be such that they are sufficiently large to integrate a relevant part of the channel to be protected and at the same time to reject adjacent channels.

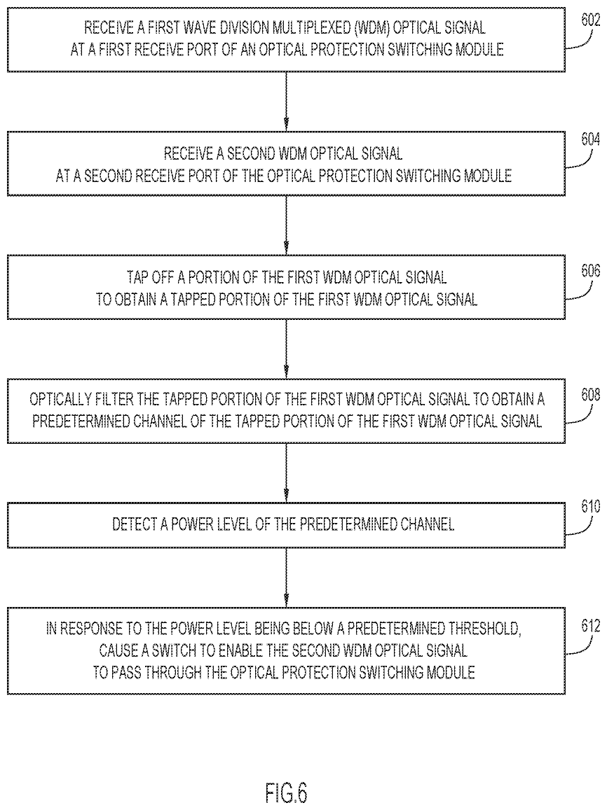

FIG. 6 is a flowchart showing a series of operations that may be performed by the optical protection switching module, according to an example embodiment. At 602, an operation includes receiving a first wave division multiplexed (WDM) optical signal at a first receive port of an optical protection switching module. At 604, an operation includes receiving a second WDM optical signal at a second receive port of the optical protection switching module. At 606, an operation includes tapping off a portion of the first WDM optical signal to obtain a tapped portion of the first WDM optical signal. At 608, an operation includes optically filtering the tapped portion of the first WDM optical signal to obtain a predetermined channel of the tapped portion of the first WDM optical signal. At 610, an operation includes detecting a power level of the predetermined channel. And, at 612, an operation includes, in response to the power level being below a predetermined threshold, causing a switch to enable the second WDM optical signal to pass through the optical protection switching module.

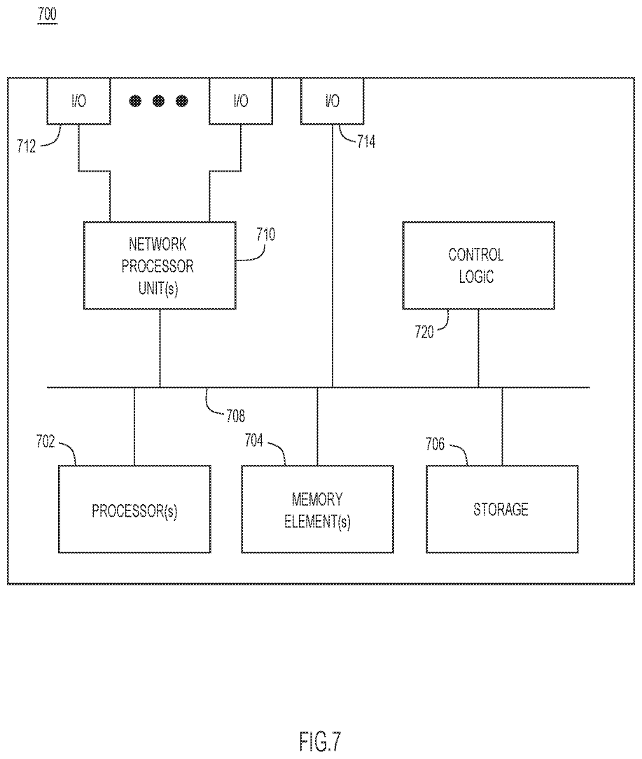

FIG. 7 is a block diagram of a computing device that may be configured to host control logic of the optical protection switching module and/or to host optical protection switching module itself, and perform techniques described herein, according to an example embodiment. In various embodiments, a computing device, such as computing device 700 or any combination of computing devices 700, may be configured as any entity/entities as discussed for the techniques depicted in connection with FIGS. 1-6 in order to perform operations of the various techniques discussed herein.

In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720 (which could include, for example, switch logic 290). In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include receiving a first wave division multiplexed (WDM) optical signal at a first receive port of an optical protection switching module, receiving a second WDM optical signal at a second receive port of the optical protection switching module, tapping off a portion of the first WDM optical signal to obtain a tapped portion of the first WDM optical signal, optically filtering the tapped portion of the first WDM optical signal to obtain a predetermined channel of the tapped portion of the first WDM optical signal, detecting a power level of the predetermined channel, and in response to the power level being below a predetermined threshold, causing a switch to enable the second WDM optical signal to pass through the optical protection switching module.

In the method, the optical protection switching module may include a transmit section and a receive section.

The method may be performed in the receive section of the optical protection switching module.

In the method, the optically filtering may be performed using a tunable optical filter.

The method may further include performing the detecting with a photo detector.

In the method, the first receive port may be one of a working receiving port and a protection receiving port, and the method further includes causing the switch to enable optical connectivity between the protection receiving port and an output of the optical protection switching module.

The method may further include tapping off a portion of the second WDM optical signal to obtain a tapped portion of the second WDM optical signal, optically filtering the tapped portion of the second WDM optical signal to obtain the predetermined channel of the tapped portion of the second WDM optical signal, detecting a power level of the predetermined channel, and communicating a result of the detecting to switch logic of the optical protection switching module.

The method may further include causing the switch to enable the first WDM optical signal to pass through the optical protection switching module.

In the method, optically filtering the tapped portion of the second WDM optical signal may be performed by another optical filter.

In the method, the another optical filter may be a tunable optical filter.

In another embodiment, a device may be provided and may include a first optical receiving port, a second optical receiving port, an optical switch having respective inputs connected to the first receiving port and the second receiving port, an optical output port connected to an output of the optical switch, switching logic configured to control which of the first optical receiving port and the second optical receiving port is connected to the optical output port, a first optical filter, tuned to a predetermined channel, in communication with the first optical receiving port, and a first photo detector in communication with an output of the first optical filter, wherein the switching logic, in response to an output of the first photo detector, is configured to cause the optical switch to enable one of the first optical receiving port and the second optical receiving port to be optically connected to the output of the optical switch.

The device may be an optical protection switching module.

The optical protection switching module may include a transmit section and a receive section.

In the device, the predetermined channel may be a selected channel from a wave division multiplexed (WDM) optical signal.

In the device, the first optical filter may be a tunable optical filter.

The device may further include a second optical filter, tuned to the predetermined channel, in communication with the second optical receiving port, and a second photo detector in communication with an output of the second optical filter, wherein an output of the second photo detector is in communication with the switching logic.

In still another embodiment, a system includes a working optical path, a protection optical path, and an optical protection switching module configured to enable communication via one of the working optical path and the protection optical path, the optical protection switching module including: a first optical receiving port, a second optical receiving port, an optical switch having respective inputs connected to the first optical receiving port and the second optical receiving port, an optical output port connected to an output of the optical switch, switching logic configured to control which of the first optical receiving port and the second optical receiving port is connected to the optical output port, a first optical filter, tuned to a predetermined channel of a wave division multiplexed (WDM) optical signal, in communication with the first optical receiving port, and a first photo detector in communication with an output of the first optical filter.

In the system, the switching logic, in response to an output of the first photo detector, may be configured to cause the optical switch to enable one of the first optical receiving port and the second optical receiving port to be optically connected to the output of the optical switch.

In the system, the first optical filter may be a tunable optical filter.

The system may further include a second optical filter, tuned to the predetermined channel, in communication with the second optical receiving port, and a second photo detector in communication with an output of the second optical filter, wherein an output of the second photo detector is in communication with the switching logic.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
receiving a first wave division multiplexed (WDM) optical signal at a first receive port of an optical protection switching module;
receiving a second WDM optical signal at a second receive port of the optical protection switching module;
tapping off a portion of the first WDM optical signal to obtain a tapped portion of the first WDM optical signal;
optically filtering the tapped portion of the first WDM optical signal to obtain a predetermined channel of the tapped portion of the first WDM optical signal;
detecting a power level of the predetermined channel; and
in response to the power level being below a predetermined threshold, causing a switch to enable the second WDM optical signal to pass through the optical protection switching module.

2. The method of claim 1, wherein the optical protection switching module includes a transmit section and a receive section.

3. The method of claim 2, wherein the method is performed in the receive section of the optical protection switching module.

4. The method of claim 1, wherein the optically filtering is performed using a tunable optical filter.

5. The method of claim 1, further comprising performing the detecting with a photo detector.

6. The method of claim 1, wherein the first receive port is one of a working receiving port and a protection receiving port, and the method further comprises causing the switch to enable optical connectivity between the protection receiving port and an output of the optical protection switching module.

7. The method of claim 1, further comprising:
tapping off a portion of the second WDM optical signal to obtain a tapped portion of the second WDM optical signal;
optically filtering the tapped portion of the second WDM optical signal to obtain the predetermined channel of the tapped portion of the second WDM optical signal;
detecting a power level of the predetermined channel; and
communicating a result of the detecting to switch logic of the optical protection switching module.

8. The method of claim 7, further comprising causing the switch to enable the first WDM optical signal to pass through the optical protection switching module.

9. The method of claim 7, wherein optically filtering the tapped portion of the second WDM optical signal is performed by another optical filter.

10. The method of claim 9, wherein the another optical filter is a tunable optical filter.

11. A device comprising:
a first optical receiving port;
a second optical receiving port;
an optical switch having respective inputs connected to the first optical receiving port and the second optical receiving port;
an optical output port connected to an output of the optical switch;
switching logic configured to control which of the first optical receiving port and the second optical receiving port is connected to the optical output port;
a first optical filter, tuned to a predetermined channel, in communication with the first optical receiving port; and
a first photo detector in communication with an output of the first optical filter,
wherein the switching logic, in response to an output of the first photo detector, is configured to cause the optical switch to enable one of the first optical receiving port and the second optical receiving port to be optically connected to the output of the optical switch.

12. The device of claim 11, wherein the device is an optical protection switching module.

13. The device of claim 12, wherein the optical protection switching module comprises a transmit section and a receive section.

14. The device of claim 11, wherein the predetermined channel is a selected channel from a wave division multiplexed (WDM) optical signal.

15. The device of claim 11, wherein the first optical filter is a tunable optical filter.

16. The device of claim 11, further comprising:
a second optical filter, tuned to the predetermined channel, in communication with the second optical receiving port; and
a second photo detector in communication with an output of the second optical filter,
wherein an output of the second photo detector is in communication with the switching logic.

17. A system comprising:
a working optical path;
a protection optical path; and
an optical protection switching module configured to enable communication via one of the working optical path and the protection optical path, the optical protection switching module comprising:
a first optical receiving port;
a second optical receiving port;
an optical switch having respective inputs connected to the first optical receiving port and the second optical receiving port;
an optical output port connected to an output of the optical switch;
switching logic configured to control which of the first optical receiving port and the second optical receiving port is connected to the optical output port;
a first optical filter, tuned to a predetermined channel of a wave division multiplexed (WDM) optical signal, in communication with the first optical receiving port; and
a first photo detector in communication with an output of the first optical filter.

18. The system of claim 17, wherein the switching logic, in response to an output of the first photo detector, is configured to cause the optical switch to enable one of the first optical receiving port and the second optical receiving port to be optically connected to the output of the optical switch.

19. The system of claim 17, wherein the first optical filter is a tunable optical filter.

20. The system of claim 17, further comprising:
a second optical filter, tuned to the predetermined channel, in communication with the second optical receiving port; and
a second photo detector in communication with an output of the second optical filter,
wherein an output of the second photo detector is in communication with the switching logic.
